(19) United States
(12) Patent Application Publication
(10) Pub. No.: US 2014/0163713 A1
(43) Pub. Date: Jun. 12, 2014

(54) METHOD AND SYSTEM FOR MANAGING A PLURALITY OF COMPLEX ASSETS

(71) Applicant: GENERAL ELECTRIC COMPANY, Schenectady, NY (US)

(72) Inventors: John Anderson Fergus Ross, Niskayuna, NY (US); Mark Lewis Grabb, Burnt Hills, NY (US)

(73) Assignee: GENERAL ELECTRIC COMPANY, Schenectady, NY (US)

(21) Appl. No.: 13/712,619

(22) Filed: Dec. 12, 2012

(51) Int. Cl. G05B 19/02

(52) U.S. Cl. CPC G05B 19/02
USPC 700/108

(57) ABSTRACT

A system and method for managing a system of a plurality of complex assets are provided. The system includes a processor-based asset management and analytics tool wherein the processor is communicatively coupled to a memory and the tool includes a plurality of asset analytics engines each associated with a complex asset of a plant and each communicatively coupled to a source of data relating to the complex asset, a plant analytics engine communicatively coupled to each of the plurality of asset analytics engines and configured to receive an output generated by at least some of the plurality of asset analytics engines, the plant analytics engine configured to generate an operational state of the plant based on the received output, and an output module configured to transmit the received state to a user.

### BACKGROUND OF THE INVENTION

The field of the invention relates generally to systems of a plurality of complex assets, and more specifically, to a method and system for managing a system of a plurality of complex assets,

At least some known industrial plants, large complex systems of components, and other systems that include many parts are difficult to forecast in terms of the impact of alternate components or parts on the overall cost, performance, maintenance requirements, and/or labor costs to build and operate the system. Moreover, financial considerations for raw materials, purchased components, and regulatory externalities also make forecasting the cost-benefit of various possible configurations of the equipment imprecise.

### BRIEF DESCRIPTION OF THE INVENTION

In one embodiment, a system for managing a system of a plurality of complex assets includes a processor-based asset management and analytics tool wherein the processor is communicatively coupled to a memory and the tool includes a plurality of asset analytics engines each associated with a complex asset of a plant and each asset analytics engine is communicatively coupled to a source of data relating to the complex asset, a plant analytics engine communicatively coupled to each of the plurality of asset analytics engines and configured to receive an output generated by at least some of the plurality of asset analytics engines, the plant analytics engine configured to generate an operational state of the plant based on the received output, and an output module configured to transmit the received state to a user.

In another embodiment, a method of managing a system of a plurality of complex assets using a processor-based asset management and analytics tool that includes a processor communicatively coupled to a memory includes receiving, by each of a plurality of asset analytics engines, a static input, a real-time input, and a periodically updated input, wherein each input is associated with a complex asset of a plant and each communicatively coupled to a source of data relating to the complex asset. The method also includes receiving, by a plant analytics engine, an output generated by at least some of the plurality of asset analytics engines, generating an operational state of the plant based on the received output, and outputting the generated state to a user.

In yet another embodiment, one or more non-transitory computer-readable storage media having computer-executable instructions embodied thereon is provided. When executed by at least one processor, the computer-executable instructions cause the at least one processor to receive, by each of a plurality of asset analytics engines, a static input, a real-time input, and a periodically updated input wherein each input associated with a complex asset of a plant and each of the plurality of asset analytics engines are communicatively coupled to a source of data relating to the complex asset. The computer-executable instructions further cause the at least one processor to receive, by a plant analytics engine, an output generated by at least some of the plurality of asset analytics engines, generate an operational state of the plant based on the received output, and output the generated state to a user.

### BRIEF DESCRIPTION OF THE DRAWINGS

FIGS. 1-4 show exemplary embodiments of the method and system described herein.

FIG. 1 is a block diagram an exemplary equipment layout of an industrial plant in accordance with an exemplary embodiment of the present disclosure.

FIG. 2 is a partial cut away view of a locomotive in accordance with an exemplary embodiment of the present disclosure.

FIG. 3 is an asset management and analytics tool (AMAT) that may be used with the industrial plant shown in FIG. 1, the locomotive shown I FIG. 2, or any other system including a plurality of complex assets coupled together and configured to operate in a coordinated manner.

FIG. 4 is a flow diagram of a method of managing a system of a plurality of complex assets using a processor-based asset management and analytics tool in accordance with an exemplary embodiment of the present disclosure.

### DETAILED DESCRIPTION OF THE INVENTION

The following detailed description illustrates embodiments of the invention by way of example and not by way of limitation. It is contemplated that the invention has general application to analytical and methodical embodiments of managing a system of a plurality of complex assets in industrial, commercial, and residential applications.

As used herein, an element or step recited in the singular and preceded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

An industrial plant utilizes many assets (motors, valves, etc.) for production. Other significant systems of equipment also include many separately modeled components. A cost-benefit of proposed assets are analyzed, typically, during the design stages of the complex system. Subsequent cost-benefit analyses may be performed periodically after plant production commences. Embodiments of the present disclosure describe a new analytics paradigm for plant creation and operation. The described system:

(1) captures the key operational features of vendor assets with an asset description language (ADL);

(2) provides a simulator to simulate the plant operation;

(3) provides access to vendor asset models, described via ADL;

(4) provides on-line what-if analysis to automatically ascertain whether an asset that is not currently part of the plant would provide value or if a current asset requires maintenance;

(5) provides automatic financing options for the value-adding assets;

(6) provides installation schedules;

(7) provides maintenance schedules.

The analytics system also supports what-if analysis for vendors, e.g. marketing dept., to decide what features a new product offering should include. Note the term plant here should not constrain the application, e.g., the “plant” may be an asset with many components such as a locomotive.

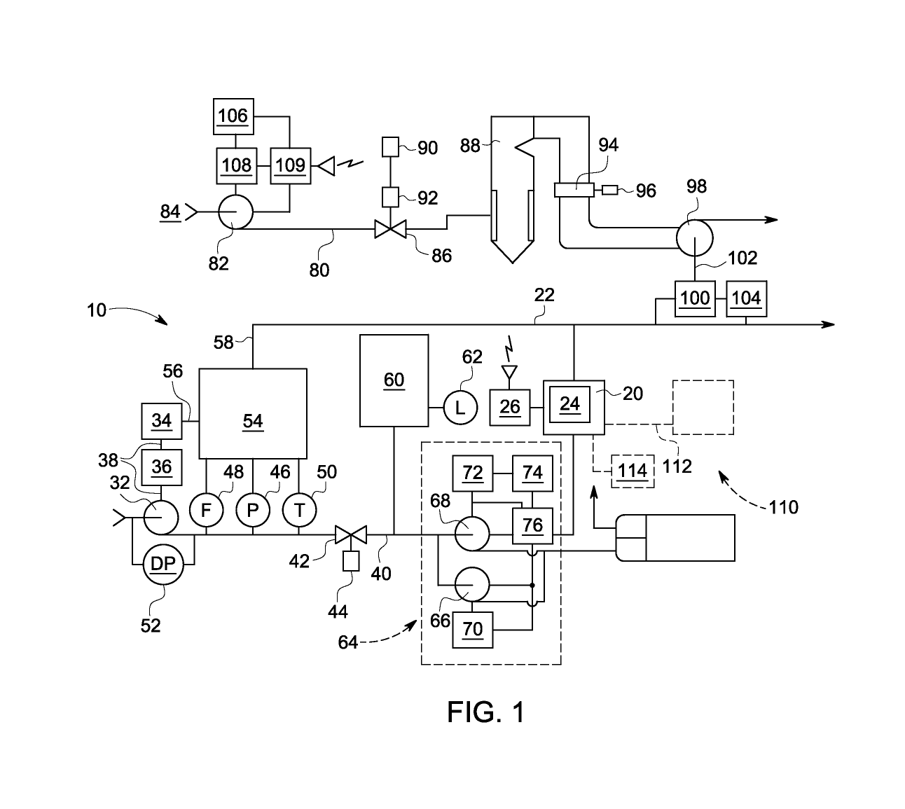

FIG. 1 is a block diagram an exemplary equipment layout of an industrial plant 10 in accordance with an exemplary embodiment of the present disclosure. Industrial plant 10 may include a plurality of pumps, motors, fans, and process monitoring sensors that are coupled in flow communication through interconnecting piping and communicatively coupled to a control system through one or more remote input/output (I/O) modules and interconnecting cabling and/or wireless communication. In the exemplary embodiment, industrial plant 10 includes a distributed control system (DCS) 20 including a network backbone 22. Network backbone 22 may be a hardwired data communication path fabricated from twisted pair cable, shielded coaxial cable or fiber optic cable, for example, or may be at least partially wireless. DCS 20 may also include a processor 24 that is communicatively coupled to equipment that is located at industrial plant 10, or at remote locations, through network backbone 22. It is to be understood that any number of machines may be communicatively connected to the network backbone 22. A portion of the machines may be hardwired to network backbone 22, and another portion of the machines may be wirelessly coupled to backbone 22 via a base station 26 that is communicatively coupled to DCS 20. Wireless base station 26 may be used to expand the effective communication range of DCS 20, such as with equipment or sensors located remotely from industrial plant 10 but, still interconnected to one or more systems within industrial plant 10.

DCS 20 may be configured to receive and display operational parameters associated with a plurality of equipment, and to generate automatic control signals and receive manual control inputs for controlling the operation of the equipment of industrial plant 10. In the exemplary embodiment, DCS 20 may include a software code segment configured to control processor 24 to analyze data received at DCS 20 that allows for on-line monitoring and diagnosis of the industrial plant machines. Process parameter data may be collected from each machine, including pumps and motors, associated process sensors, and local environmental sensors, including for example, vibration, seismic, ambient temperature and ambient humidity sensors. The data may be pre-processed by a local diagnostic module or a remote input/output module, or may be transmitted to DCS 20 in raw form.

Specifically, industrial plant 10 may include a first process system 30 that includes a pump 32 coupled to a motor 34 through a coupling 36, for example a hydraulic coupling, and interconnecting shafts 38. The combination of pump 32, motor 34, and coupling 36, although comprising separate components, may operate as a single system, such that conditions affecting the operation of one component of the combination may affect each of the other components of the combination. Accordingly, condition monitoring data collected from one component of the combination that indicates a failure of a portion of the component or an impending failure of the component may be sensed at the other components of the combination to confirm the failure of the component and/or facilitate determining a source or root cause of the failure.

Pump 32 may be connected to a piping system 40 through one or more valves 42. Valve 42 may include an actuator 44, for example, but, not limited to, an air operator, a motor operator, and a solenoid. Actuator 44 may be communicatively coupled to DCS 20 for remote actuation and position indication. In the exemplary embodiment, piping system 40 may include process parameter sensors, such as a pressure sensor 46, a flow sensor 48, a temperature sensor 50, and a differential pressure (DP) sensor 52. In an alternative embodiment, piping system 40 may include other sensors, such as turbidity, salinity, pH, specific gravity, and other sensors associated with a particular fluid being carried by piping system 40. Sensors 46, 48, 50 and 52 may be communicatively coupled to a field module 54, for example, a preprocessing module, or remote I/O rack.

Motor 34 may include one or more of a plurality of sensors (not shown) that are available to monitor the operating condition of electrodynamic machines. Such sensors may be communicatively coupled to field module 54 through an interconnecting conduit 56, for example, copper wire or cable, fiber cable, and wireless technology.

Field module 54 may communicate with DCS 20 through a network segment 58. The communications may be through any network protocol and may be representative of preprocessed data and or raw data. The data may be transmitted to processor 24 continuously in a real-time environment or to processor 24 intermittently based on an automatic arrangement or a request for data from processor 24. DCS 20 includes a real time clock in communication with network backbone 22, for time stamping process variables for time-based comparisons. As used herein, real-time refers to outcomes occurring at a substantially short period after a change in the inputs affecting the outcome, for example, transmitting data occurs shortly after a value changes. The period is the amount of time between iterations of a regularly repeated task or between one task and another. The time period is a result of design parameters of the real-time system that may be selected based on the importance of the outcome and/or the capability of the system implementing processing of the inputs to generate the outcome. Additionally, events occurring in real-time occur without substantial intentional delay, although circuit latencies or transmission delays may introduce unwanted delay.

Piping system 40 may include other process components, such as a tank 60 that may include one or more of a plurality of sensors available for monitoring process parameters associated with tanks, such as, a tank level sensor 62. Tank 60 may provide a surge volume for fluid pumped by pump 32 and/or may provide suction pressure for downstream components, such as, skid 64. Skid 64 may be a pre-engineered and prepackaged subsystem of components that may be supplied by an OEM. Skid 64 may include a first pump 66 and a second pump 68. In the exemplary embodiment, first pump is coupled to a motor that is directly coupled to a power source (not shown) through a circuit breaker (not shown) that may be controlled by DCS 20. Second pump 68 is coupled to a motor 72 that is coupled to the power source through a variable speed drive (VSD) 74 that controls a rotational speed of motor 72 in response to commands from a skid controller 76. Each of pumps 66 and 68, and motors 70 and 72, and VSD 74 may include one or more sensors associated with respective operating parameters of each type of equipment as described above in relation to pump/motor/coupling 32, 34, and 36 combination. Skid controller 76 receives signals from the sensors and may transmit the signals to DCS 20 without preprocessing or after processing the data in accordance with predetermined algorithms residing within skid controller 76. Skid controller 76 may also process the signals and generate control signals for one or more of pumps 66 and 68, and motors 70 and 72, and VSD 74 without transmitting data to DCS 20. Skid controller may also receive commands from DCS 20 to modify the operation of skid 64 in accordance therewith.

A second piping system 80 may include a fan 82 that receives air from an ambient space 84 and directs the air through a valve or damper 86 to a component, such as a furnace 88. Damper 86 may include position sensors 90 and 92 to detect an open and closed position of damper 86. Furnace 88 may include a damper 94 that may be operated by actuator 96, which may be, for example, a motor actuator, a fluid powered piston actuator, or other actuator, which may be controlled remotely by DCS 20 through a signal transmitted through a conduit (not shown). A second fan 98 may take a suction on furnace 88 to remove combustion gases from furnace 88 and direct the combustion gases to a smoke stack or chimney (not shown) for discharge to ambient space 84. Fan 98 may be driven by a motor 100 through a shaft 102 coupled between fan 98 and motor 100. A rotational speed of motor 100 may be controlled by a VSD 104 that may be communicatively coupled to DCS 20 though network backbone 22. Fan 82 may be driven by an engine 106, such as an internal combustion engine, or a steam, water, wind, or gas turbine, or other driver, through a coupling 108, which may be hydraulic or other power conversion device. Each of the components may include various sensors and control mechanisms that may be communicatively coupled to DCS 20 through network backbone 22 or may communicate with DCS 20 through a wireless transmitter/receiver 109 to wireless base station 26.

DCS 20 may operate independently to control industrial plant 10, or may be communicatively coupled to one or more other control systems 110. Each control system may communicate with each other and DCS 20 through a network segment 112, or may communicate through a network topology, for example, a star (not shown).

In the exemplary embodiment, plant 10 includes a continuous integrated machinery monitoring system (CIMMS) 114 that communicates with DCS 20 and other control systems 110. CIMMS 114 may also be embodied in a software program segment executing on DCS 20 and/or one or more of the other control systems 110. Accordingly, CIMMS 114 may operate in a distributed manner, such that a portion of the software program segment executes on several processors concurrently. As such, CIMMS 114 may be fully integrated into the operation of DCS 20 and other control systems 110. CIMMS 114 analyzes data received by DCS 20 and the other control systems 110 determine a health the machines and/or a process employing the machines using a global view of the industrial plant 10. CIMMS 114 analyzes combinations of drivers and driven components, and process parameters associated with each combination to correlate machine health findings of one machine to machine health indications from other machines in the combination, and associated process or environmental data. CIMMS 114 uses direct measurements from various sensors available on or associated with each machine and derived quantities from all or a portion of all the sensors in industrial plant 10. CIMMS 114, using predetermined analysis rules, determines a failure or impending failure of one machine and automatically, in real-time correlates the data used to determine the failure or impending failure with equivalent data derived from the operating parameters of other components in the combination or from process parameters. CIMMS 114 also provides for performing trend analysis on the machine combinations and displaying data and/or trends in a variety of formats so as to afford a user of CIMMS 114 an ability to quickly interpret the health assessment and trend information provided by CIMMS 114.

Although various combinations of machines are generally illustrated as motor/pump, motor/fan, or engine/fan combinations, it should be understood these combinations are exemplary only, and CIMMS 114 is configured to analyze any combination of driver/driven machines.

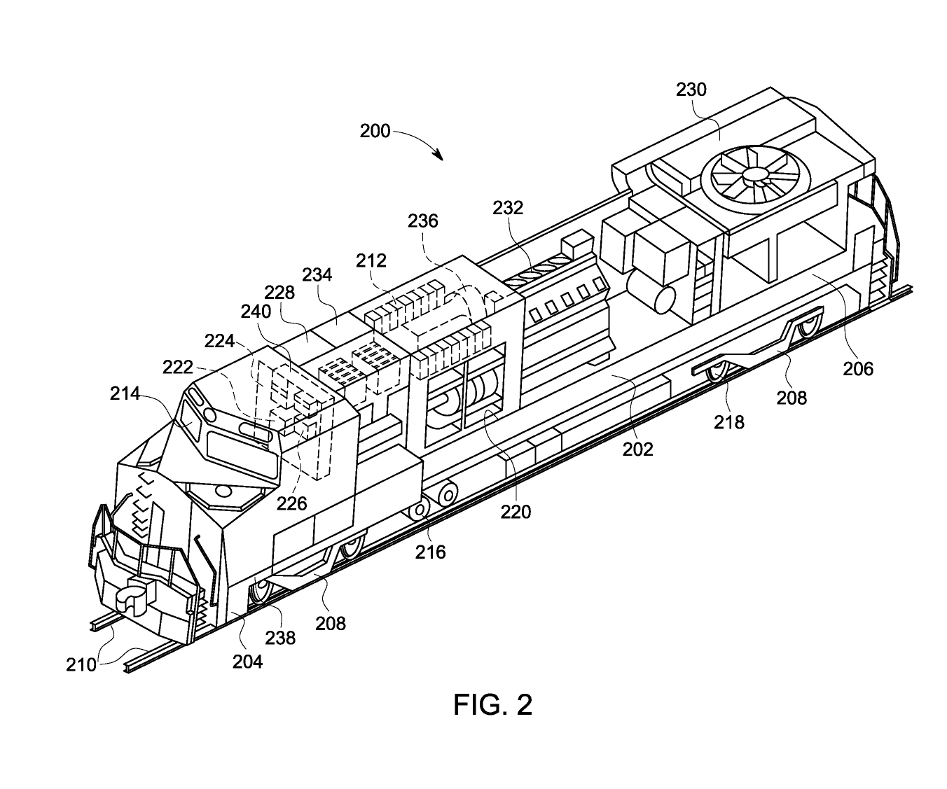

FIG. 2 is a partial cut away view of an exemplary locomotive 200. Locomotive 200 includes a platform 202 having a first end 204 and a second end 206. A propulsion system 208, or truck is coupled to platform 202 for supporting, and propelling platform 202 on a pair of rails 210. An equipment compartment 212 and an operator cab 214 are coupled to platform 202. An air and air brake system 216 provides compressed air to locomotive 200, which uses the compressed air to actuate a plurality of air brakes 218 on locomotive 200 and railcars (not shown) behind it. An auxiliary alternator system 220 supplies power to all auxiliary equipment. An intra-consist communications system 222 collects, distributes, and displays consist data across all locomotives in a consist.

A cab signal system 224 links the wayside (not shown) to a train control system 226. In particular, system 224 receives coded signals from a pair of rails 210 through track receivers (not shown) located on the front and rear of the locomotive. The information received is used to inform the locomotive operator of the speed limit and operating mode. A distributed power control system 228 enables remote control capability of multiple locomotive consists coupled in the train. System 228 also provides for control of tractive power in motoring and braking, as well as air brake control.

An engine cooling system 230 enables engine 232 and other components to reject heat to cooling water. In addition, system 230 facilitates minimizing engine thermal cycling by maintaining an optimal engine temperature throughout the load range, and facilitates preventing overheating in tunnels. An equipment ventilation system 234 provides cooling to locomotive 200 equipment.

A traction alternator system 236 converts mechanical power to electrical power which is then provided to propulsion system 208. Propulsion system 208 enables locomotive 200 to move and includes at least one traction motor 238 and dynamic braking capability. In particular, propulsion system 208 receives power from traction alternator 236, and through traction motors 238 moves locomotive 200. Locomotive 200 systems are monitored by an on-board monitor (OBM) system 240.

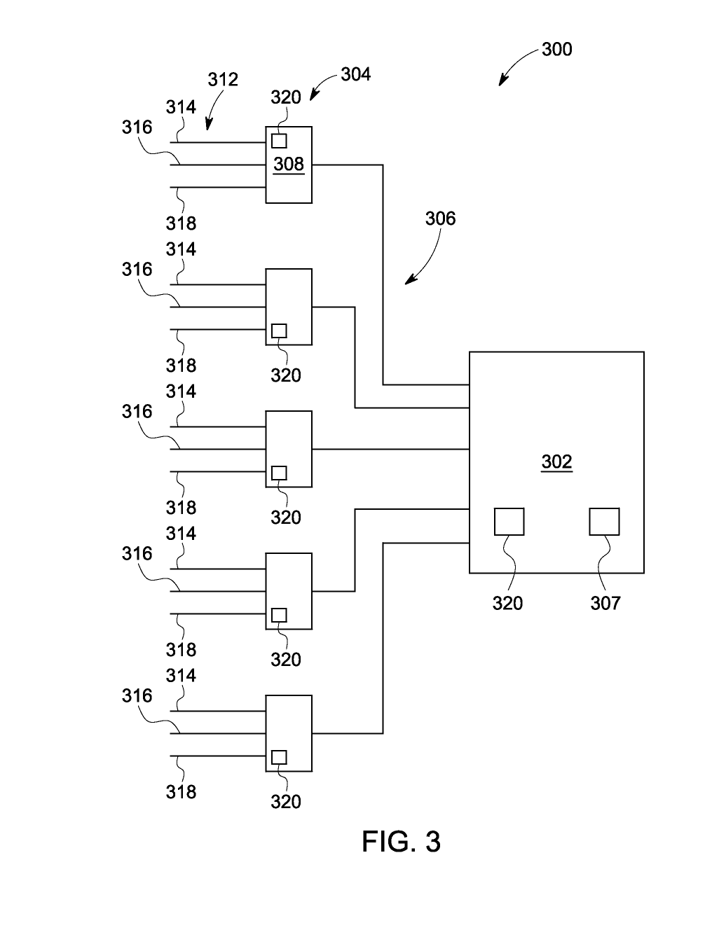

FIG. 3 is an asset management and analytics tool (AMAT) 300 that may be used with industrial plant 10, locomotive 200, or any other system including a plurality of complex assets coupled together and configured to operate in a coordinated manner. In the exemplary embodiment, AMAT 300 includes a plant analytics engine 302 configured to control and coordinate a plurality of asset analytics engines 304. Plant analytics engine 302 is communicatively coupled to the plurality of asset analytics engines 304 through a plant network or other network, such as, but not limited to, the Internet or individual channels 306, including wired and wireless connections. Moreover, plant analytics engine 302 includes a simulator module 307 configured to simulate the operation of plant 10 while plant 10 is operating or offline.

Asset analytics engines 304 may be supplied with a respective one of the plurality of complex assets as a software model of the complex asset. For example, a supplier of induced draft (ID) fan 98 may also supply an ID fan analytics engine 308 that may be used with AMAT 300. The ID fan supplier may program engine 308 to communicate with plant analytics engine 302 directly using a common language or engine 308 may be programmed to communicate with plant analytics engine 302 through a driver (not shown). In the exemplary embodiment, engine 308 and plant analytics engine 302 communicate using an asset description language (ADL) configured as a common language platform available to all equipment suppliers, such as via an open source licensing arrangement. The ADL is configured to permit plant analytics engine 302 to control engine 308 and facilitate communication between ID fan analytics engine 308 and others of asset analytics engines 304 coupled to plant analytics engine 302.

In various embodiments, asset analytics engines 304 may include analytics engines for modeling the structure, operation, and performance of all equipment or components included within plant 10, locomotive 200, or other complex system. In the case of a power plant, engines may include various fan analytics engines, motor analytics engines, heater analytics engines, furnace analytics engines, water treatment analytics engines, and fuel delivery analytics engines. The asset analytics engines 304 receive various classes of inputs 312, such as static inputs 314, real-time inputs 316, and periodically updated inputs 318. Static inputs 314 include, but are not limited to dimensions, material coefficients, operational limitations, formulas and algorithms describing the operation or performance of the asset, and other parameters that are not expected to change during the life of the asset. Static inputs 314 permit describing the asset in a model format. Static inputs 314 are generally stored within asset analytics engine 304 or are available to the associated asset analytics engine 304 through communication with a memory device 320 where the information is stored.

Real-time inputs 316 are generally received by the analytics engine from a plant data system, such as, DCS 20, train control system 226, or distributed power control system 228 and are operated on by the analytics engine to generate outputs, which are communicated to plant analytics engine 302. In various embodiments, real-time inputs 316 include process parameters such as, but not limited to pressures, temperatures, speeds, concentrations, equipment operating conditions, interlock statuses, and other sensed or inferred parameters that indicate the condition or operation of plant 10, locomotive 200, or other complex system.

Periodically updated inputs 318 may include non-sensed parameters that are manually input into asset analytics engine 304. Moreover, inputs that change over a long period of time may only be periodically updated in the analytics engine. Further, externalities that may affect the results of the analytics engines, but are not measurable may also be updated periodically. For example, tax incentives, environmental or other regulations, financial parameters, such as, but not limited to interest rates, contract terms, operator skill, outage plans or schedules, and/or seasonal variations or considerations may be updated periodically and/or manually.

Plant analytics engine 302 uses the outputs generated by asset analytics engine 304 to determine, either in real-time or in what-if scenarios, the impact of changes in the operation, performance, or assumptions of the complex assets. In various embodiments, degradation models may be used to forecast when a plant should have an outage or when a locomotive, airplane, or other vehicle should be removed from service for overhaul. Additionally, plant analytics engine 302 may be used to compare the benefits of replacing one or more complex assets with respect to continued operation of the complex asset. Plant analytics engine 302 may also be used to determine the impact of environmental regulations on plant operation and performance. In various embodiments, vendors of equipment may use plant analytics engine 302 to check new equipment designs to verify the improved designs are compatible with the existing plant equipment. Cost-benefit analyses may be performed using what-if scenarios to determine if improvements to different combinations of equipment can yield greater efficiency or other operational improvements than improvements to one piece of equipment alone. Vendor asset models may be described using ADL. ADL permits multiple vendors to describe their respective complex asset in a common language that asset analytics engine 304 may use to analyze the operation of the complex asset as if it were operating in plant 10. Any number of vendor asset models using ADL can be accommodated by plant analytics engine 302.

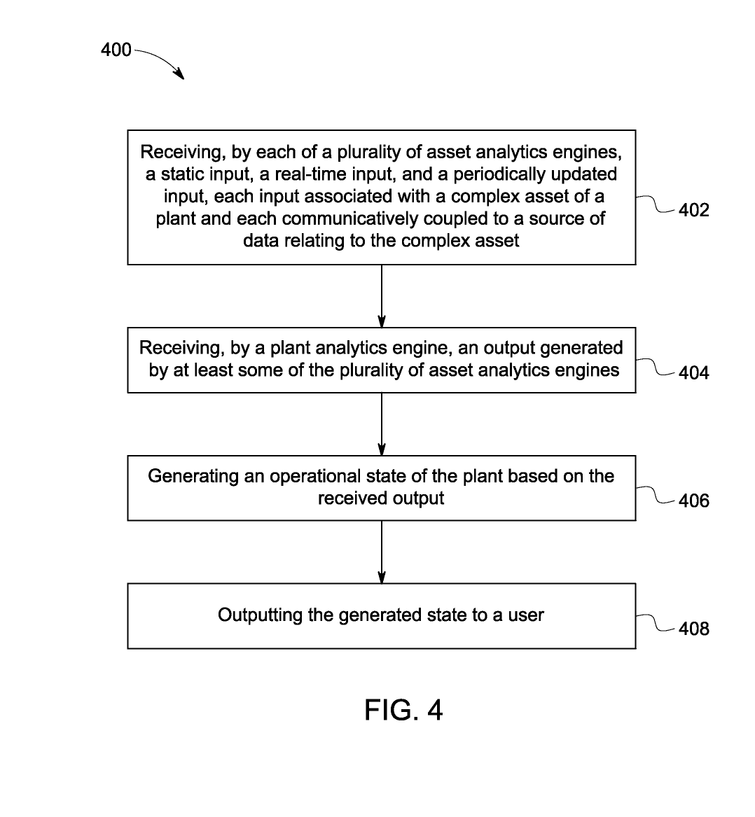

FIG. 4 is a flow diagram of a method 400 of managing a system of a plurality of complex assets using a processor-based asset management and analytics tool in accordance with an exemplary embodiment of the present disclosure. The plurality of complex assets includes both assets existing in the system and assets being considered to be added to the system or assets being considered for replacing an existing asset. In the exemplary embodiment, a processor is communicatively coupled to a memory, and the method includes receiving 402, by each of a plurality of asset analytics engines, a static input, a real-time input, and a periodically updated input, each input associated with a complex asset of a plant and each communicatively coupled to a source of data relating to the complex asset. Method 400 also includes receiving 404, by a plant analytics engine, an output generated by at least some of the plurality of asset analytics engines, generating 406 an operational state of the plant based on the received output, and outputting 408 the generated state to a user.

As used herein, an operational state refers to an operating condition and/or one or more sets of operating parameters. In one embodiment, the operational state is determined to reduce resource consumption, for example, energy consumption, improve efficiency, improve maintenance schedules, and/or reduce financial resource requirements. In various embodiments, the state is used to compare different configurations of assets according to the performance of the entire plant. The performance may relate to for example, but not limited to, an efficiency of the plant, an environmental performance of the plant, an economic performance of the plant, or any other parameter related to the operation of the plant.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by processor 320, including RAM memory, ROM memory, EPROM memory, EEPROM memory, and non-volatile RAM (NVRAM) memory. The above memory types are exemplary only, and are thus not limiting as to the types of memory usable for storage of a computer program.

As will be appreciated based on the foregoing specification, the above-described embodiments of the disclosure may be implemented using computer programming or engineering techniques including computer software, firmware, hardware or any combination or subset thereof, wherein the technical effect includes (1) capturing key operational features of vendor assets with an asset description language (ADL); (2) providing a simulator to simulate plant operation; (3) providing access to vendor asset models, described via ADL; (4) providing an on-line what-if analysis to automatically ascertain whether an asset that is not currently part of the plant would provide value or if a current asset requires maintenance; (5) providing automatic financing options for the value-adding assets; (6) providing installation schedules; and (7) providing maintenance schedules. Any such resulting program, having computer-readable code means, may be embodied or provided within one or more computer-readable media, thereby making a computer program product, i.e., an article of manufacture, according to the discussed embodiments of the disclosure. The computer readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

Many of the functional units described in this specification have been labeled as modules, in order to more particularly emphasize their implementation independence. For example, a module may be implemented as a hardware circuit comprising custom very large scale integration (“VLSI”) circuits or gate arrays, off-the-shelf semiconductors such as logic chips, transistors, or other discrete components. A module may also be implemented in programmable hardware devices such as field programmable gate arrays (FPGAs), programmable array logic, programmable logic devices (PLDs) or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The above-described embodiments of a method and system of managing a system of a plurality of complex assets provides a cost-effective and reliable means for generating an operational state of the plant based on a received output from a plurality of asset analytics engines that analyze the performance, operation, and cost of a plurality of plant assets.. More specifically, the methods and systems described herein facilitate generating an operational state of the plant, by a plant analytics engine and based on the output generated by at least some of the plurality of asset analytics engines. As a result, the methods and systems described herein facilitate managing the operation of a system that includes a plurality of inter-related systems in a cost-effective and reliable manner.

An exemplary methods and system for managing a system of a plurality of complex assets are described above in detail. The apparatus illustrated is not limited to the specific embodiments described herein, but rather, components of each may be utilized independently and separately from other components described herein. Each system component can also be used in combination with other system components.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A processor-based asset management and analytics tool, said processor communicatively coupled to a memory, said tool comprising:
a plurality of asset analytics engines each associated with a complex asset of a plant and each communicatively coupled to a source of data relating to the complex asset;
a plant analytics engine communicatively coupled to each of the plurality of asset analytics engines and configured to receive an output generated by at least some of the plurality of asset analytics engines, said plant analytics engine configured to generate an operational state of the plant based on the received output; and
an output module configured to transmit the received state to a user.

2. The asset management and analytics tool of claim 1, wherein the source of data includes at least one of static inputs, real-time inputs, and periodically updated inputs.

3. The asset management and analytics tool of claim 2, wherein the static inputs include at least one of dimensions, material coefficients, operational limitations, formulas and algorithms describing the operation or performance of the asset.

4. The asset management and analytics tool of claim 2, wherein, the static inputs include parameters that are not expected to change during the life of the asset.

5. The asset management and analytics tool of claim 2, wherein the static inputs are at least one of stored within the respective analytics engine and are available to the respective analytics engine through communication with a memory device where information of the static inputs is stored.

6. The asset management and analytics tool of claim 2, wherein the real-time inputs include at least one of pressures, temperatures, speeds, concentrations, equipment operating conditions, interlock statuses, and other sensed or inferred parameters that indicate the condition or operation of the plant.

7. The asset management and analytics tool of claim 2, wherein the real-time inputs are received from a control system that acquires the real-time inputs from parameter sensors positioned at least one of proximate to the complex asset, within the complex assets and in conduits connecting the complex assets to other complex assets.

8. The asset management and analytics tool of claim 2, wherein the periodically updated inputs include at least one of non-sensed parameters that are automatically input into the analytics engine or manually input into the analytics engine, inputs that change over a relatively long period of time, externalities including at least one of tax incentives, environmental or other regulations, financial parameters including at least one of interest rates, contract terms, operator skill, outage plans or schedules, and seasonal variations or considerations.

9. A method of managing a system of a plurality of complex assets using a processor-based asset management and analytics tool comprising a processor communicatively coupled to a memory, said method comprising:
receiving, by each of a plurality of asset analytics engines, a static input, a real-time input, and a periodically updated input, each input associated with a complex asset of a plant and each communicatively coupled to a source of data relating to the complex asset;
receiving, by a plant analytics engine, an output generated by at least some of the plurality of asset analytics engines;
generating an operational state of the plant based on the received output; and
outputting the generated state to a user.

10. The method of claim 9, wherein receiving the static input comprises receiving at least one of dimensions, material coefficients, operational limitations, formulas and algorithms describing the operation or performance of the asset.

11. The method of claim 9, wherein receiving the static input comprises receiving parameters that are not expected to change during the life of the asset.

12. The method of claim 9, wherein receiving the static input comprises receiving static inputs that are at least one of stored within the respective analytics engine and stored on a memory device accessible to the respective analytics engine.

13. The method of claim 9, wherein receiving the real-time inputs comprises receiving at least one of pressures, temperatures, speeds, concentrations, equipment operating conditions, interlock statuses, and other sensed or inferred parameters that indicate the condition or operation of the plant.

14. The method of claim 9, wherein receiving the real-time inputs comprises receiving real-time inputs from a control system that acquires the real-time inputs from parameter sensors positioned at least one of proximate the complex assets, within the complex assets and in conduits connecting the complex assets to other complex assets.

15. The method of claim 9, wherein receiving the periodically updated inputs comprises receiving at least one of non-sensed parameters that are manually input into analytics engine, inputs that change over a relatively long period of time, externalities including at least one of tax incentives, environmental or other regulations, financial parameters including at least one of interest rates, contract terms, operator skill, outage plans or schedules, and seasonal variations or considerations.

16. The method of claim 9, further comprising determining a cost-benefit of a modification of at least one of a configuration of a complex asset of the plant, a regulatory regime affecting the operation of the plant, and a financial deal related to capital funding or revenue of the plant.

17. One or more non-transitory computer-readable storage media having computer-executable instructions embodied thereon, wherein when executed by at least one processor, the computer-executable instructions cause the processor to:
receive, by each of a plurality of asset analytics engines, a static input, a real-time input, and a periodically updated input, each input associated with a complex asset of a plant and each communicatively coupled to a source of data relating to the complex asset;
receive, by a plant analytics engine, an output generated by at least some of the plurality of asset analytics engines;
generate an operational state of the plant based on the received output; and
output the generated state to a user.

18. The computer-readable storage media of claim 17, wherein the computer-executable instructions further cause the processor to determine a cost-benefit of a modification of at least one of a configuration of a complex asset of the plant, a regulatory regime affecting the operation of the plant, and a financial deal related to capital funding or revenue of the plant.

19. The computer-readable storage media of claim 17, wherein the computer-executable instructions include operational features of the complex asset using an asset description language (ADL).

20. The computer-readable storage media of claim 17, wherein the computer-executable instructions further cause the processor to:
receive a threshold range for the generated state of the plant;
iteratively determine a newly generated state of the plant by modifying at least one of the static input, the real-time input, and the periodically updated input;
compare each of the newly generated states of the plant to the received threshold range; and
output the newly generated states of the plant that meet the threshold range.
